(19) United States
(12) Patent Application Publication
(10) Pub. No.: US 2026/0268594 A1
(43) Pub. Date: Sep. 10, 2026

(54) BINOCULAR SIZE DISPARITY MATCHING IN EXTENDED REALITY DISPLAYS

(71) Applicant: Microsoft Technology Licensing, LLC, Redmond, WA (US)

(72) Inventors: Michaela PORUBANOVA, Seattle, WA (US); Gregory Michael LINK, Charlotte, NC (US)

(21) Appl. No.: 19/073,484

(22) Filed: Mar. 7, 2025

(51) Int. Cl. G06T 17/00; G06T 3/40

(52) U.S. Cl. CPC G06T 17/00; G06T 3/40

(57) ABSTRACT

Techniques for scaling an image in an ER system to calibrate the image for a vision prescription of a user wearing the ER system are disclosed. A service accesses diopter information for a lens that is physically disposed between an eye of the user and a display of the ER system. The service accesses the image, which is structured for display on the display. The service accesses a scaling factor based on the diopter information. Prior to the image being displayed in the display, the service applies the scaling factor to the image, resulting in generation of a scaled image that is a magnified or minimized version of the image. The service displays the scaled image in the display. The scaling factor is designed to cause the scaled image, as viewed on the display through the lens, to be of a predetermined size.

### BACKGROUND

Head mounted devices (HMDs), or other wearable devices, are becoming highly popular. These types of devices are able to provide a so-called “extended reality” experience.

The phrase “extended reality” (ER) is an umbrella term that collectively describes various different types of immersive platforms. Such immersive platforms include virtual reality (VR) platforms, mixed reality (MR) platforms, and augmented reality (AR) platforms. The ER system provides a “scene” to a user. As used herein, the term “scene” generally refers to any simulated environment (e.g., three-dimensional (3D) or two-dimensional (2D)) that is displayed by an ER system.

For reference, conventional VR systems create completely immersive experiences by restricting their users’ views to only virtual environments. This is often achieved through the use of an HMD that completely blocks any view of the real world. Conventional AR systems create an augmented-reality experience by visually presenting virtual objects that are placed in the real world. Conventional MR systems also create an augmented-reality experience by visually presenting virtual objects that are placed in the real world, and those virtual objects are typically able to be interacted with by the user. Furthermore, virtual objects in the context of MR systems can also interact with real world objects. AR and MR platforms can also be implemented using an HMD. ER systems can also be implemented using laptops, handheld devices, HMDs, and other computing systems.

Unless stated otherwise, the descriptions herein apply equally to all types of ER systems, which include MR systems, VR systems, AR systems, and/or any other similar system capable of displaying virtual content. An ER system can be used to display various different types of information to a user. Some of that information is displayed in the form of a “hologram.” As used herein, the term “hologram” generally refers to image content that is displayed by an ER system. In some instances, the hologram can have the appearance of being a 3D object while in other instances the hologram can have the appearance of being a 2D object. In some instances, a hologram can also be implemented in the form of an image displayed to a user.

Continued advances in hardware capabilities and rendering technologies have greatly increased the realism of holograms and scenes displayed to a user within an ER environment. For example, in ER environments, a hologram can be placed within the real world in such a way as to give the impression that the hologram is part of the real world. As a user moves around within the real world, the ER environment automatically updates so that the user is provided with the proper perspective and view of the hologram. This ER environment is the “scene” mentioned previously.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for scaling an image in an extended-reality (ER) system to calibrate the image for a vision prescription of a user wearing the ER system, said method being performed by the ER system and including: accessing diopter information for a lens that is physically disposed between an eye of the user and a display of the ER system; accessing the image, which is structured for display on the display; generating or accessing a scaling factor based on the diopter information; prior to the image being displayed in the display, applying the scaling factor to the image, resulting in generation of a scaled image that is a magnified or minimized version of the image; displaying the scaled image in the display; wherein: the scaling factor is designed to cause the scaled image, as viewed on the display through the lens, to be of a predetermined size.

In some aspects, the techniques described herein relate to a method for scaling an image in an extended-reality (ER) system to calibrate the image for a vision prescription of a user wearing the ER system, said method being performed by the ER system and including: accessing left diopter information for a left lens that is physically disposed between a left eye of the user and a left display of the ER system; accessing right diopter information for a right lens that is physically disposed between a right eye of the user and a right display of the ER system; accessing a left image that is structured for display on the left display; accessing a right image that is structured for display on the right display; generating or accessing a left scaling factor based on the left diopter information; generating or accessing a right scaling factor based on the right diopter information; prior to the left image being displayed in the left display, applying the left scaling factor to the left image, resulting in generation of a left scaled image; prior to the right image being displayed in the right display, applying the right scaling factor to the right image, resulting in generation of a right scaled image; displaying the left scaled image in the left display; displaying the right scaled image in the right display; wherein: the left scaling factor is designed to cause the left scaled image, as viewed on the left display through the left lens, to be of a first size, and the right scaling factor is designed to cause the right scaled image, as viewed on the right display through the right lens, to be of the same first size.

In some aspects, the techniques described herein relate to an extended reality (ER) system including: a left display; a right display; a processor system; and a storage system that stores instructions that are executable by the processor system to cause the ER system to: access left diopter information for a left lens that is physically disposed between a left eye of the user and the left display of the ER system; access right diopter information for a right lens that is physically disposed between a right eye of the user and the right display of the ER system; access a left image that is structured for display on the left display; access a right image that is structured for display on the right display; access a left scaling factor based on the left diopter information; access a right scaling factor based on the right diopter information; prior to the left image being displayed in the left display, apply the left scaling factor to the left image, resulting in generation of a left scaled image; prior to the right image being displayed in the right display, apply the right scaling factor to the right image, resulting in generation of a right scaled image; display the left scaled image in the left display; display the right scaled image in the right display; wherein: the left scaling factor is designed to cause the left scaled image, as viewed on the left display through the left lens, to be of a first size, and the right scaling factor is designed to cause the right scaled image, as viewed on the right display through the right lens, to be of the same first size.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture structured to scale images to account for intervening lenses that are positioned between the user’s eyes and the ER system’s displays.

FIGS. 2 and 3 illustrate various different perspective views of an HMD.

FIG. 4 illustrates an example of a pair of lenses that can operate in conjunction with the HMD.

FIGS. 5 and 6 illustrate other perspective views of the lenses and HMD configuration.

FIG. 7 illustrates the impact of the scaling operations performed by the disclosed service.

FIG. 8 illustrates a flowchart of an example method for scaling an image in an ER system to calibrate the image for a vision prescription of a user wearing the ER system.

FIG. 9 illustrates an example computing system that can be configured to perform any of the disclosed operations.

### DETAILED DESCRIPTION

Different image properties will have an impact on how stereoscopic images, which are used to provide the illusion of depth in an ER system, are perceived by the user of the ER system. That is, the disparity between the two stereoscopic images, which is normally a cue for perceiving depth, can become unstable when the retinal images are not aligned or are scaled differently. Other problems, such as inaccurate depth perception, unstable perception, or even binocular rivalry (i.e. where one image alternates in the user’s perceptive focus) can also occur.

As such, when the left and right eyes view images of different sizes, it is often the case that the user’s brain struggles to fuse the images properly. In addition, in some cases, when the image size disparity between the two eyes is too large, the user’s brain may not be able to fuse the images effectively, thereby leading to “binocular rivalry.” In binocular rivalry, one image may dominate the other, and depth perception from binocular disparity can be degraded or even lost.

ER systems use stereoscopic displays, which rely heavily on binocular disparity for depth. If the displayed image sizes are not equal, depth perception in the scenes can become less accurate, thereby leading to a distorted three-dimensional (3D) experience where objects do not appear at the correct depth. While in those distorted scenarios, the user’s brain may rely more heavily on other depth cues, such as motion parallax (i.e. depth cues from movement), texture gradients, or shading to estimate the distance and depth of objects. Sometimes, however, those cues might not be available.

If a user is using prescription glasses of varying magnification or prescription sizes, the magnification will carry on into the user’s experience in the ER scene. This condition is called “anisometropia” and refers to a scenario where each eye has a different refractive power. Fixing retinal image disparity (e.g., size differences) in stereoscopic displays, where the images seen by each eye are unequal, requires adjustments that ensure more accurate image fusion and depth perception.

The disclosed embodiments are designed to beneficially solve such problems. Initially, the disclosed embodiments recognize how corrective lenses can be used in conjunction with an ER system. For example, an intervening corrective lens (or a pair of lenses) may be disposed between the user’s eyes and the ER system’s display. These intervening lenses have refractive properties that, if left unaccounted for, would cause the user to perceive the two stereoscopic images as having different sizes, thereby leading to the issues mentioned above.

The disclosed embodiments are beneficially designed to scale a displayed image in a manner to account for the refractive properties of the intervening lenses. In doing so, the embodiments are able to generate two images that appear to have the same size on the eye-side area of the intervening lenses.

The embodiments provide calibrating operations with respect to the binocular size disparity to accommodate for the user’s specific diopter prescription. In doing so, the disclosed embodiments significantly improve perception and user comfort. Accordingly, these and numerous other benefits will now be described in more detail throughout the remaining portions of this disclosure.

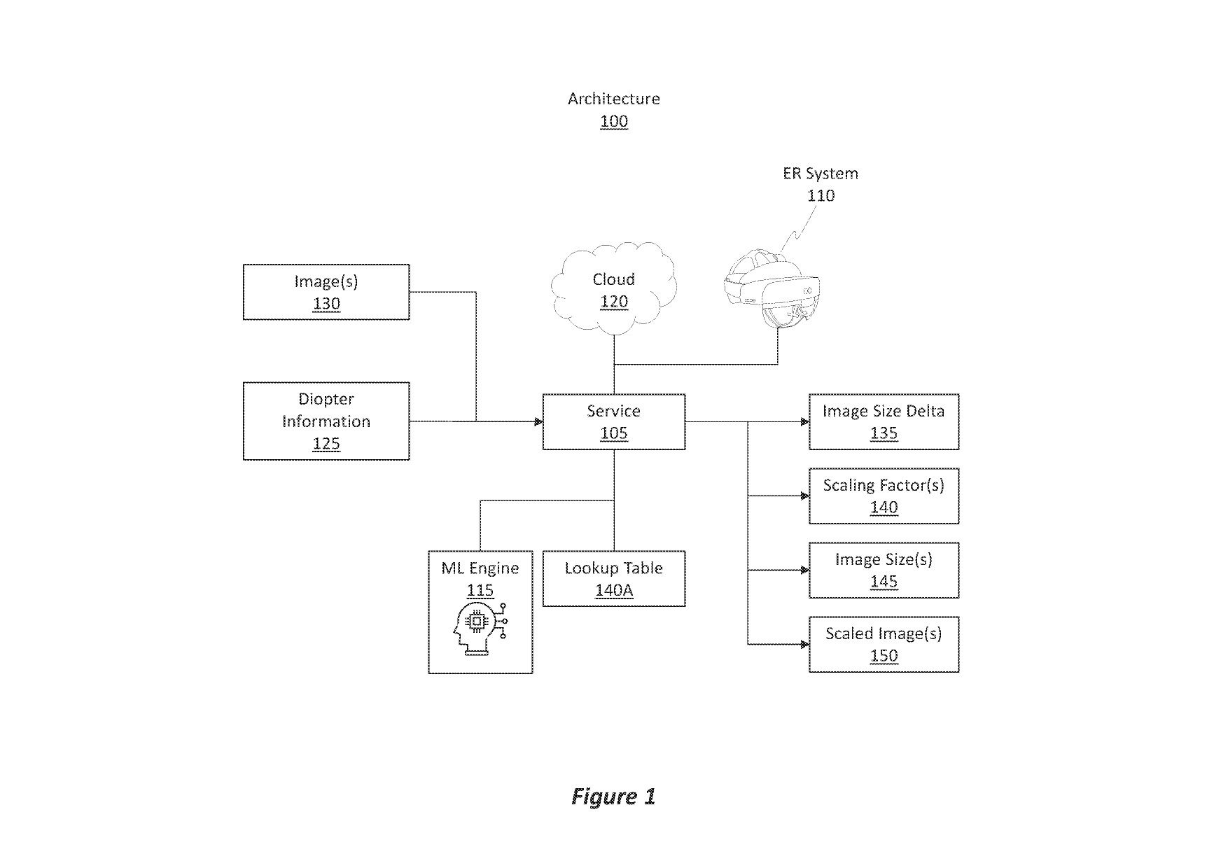

Having just described some of the high level benefits, advantages, and practical applications achieved by the disclosed embodiments, attention will now be directed to FIG. 1, which illustrates an example computing architecture 100 that can be used to achieve those benefits. Architecture 100 includes a service 105, which can be implemented by an ER system 110 comprising an HMD.

As used herein, the phrases ER system, HMD, ER platform, ER device, or wearable device can all be used interchangeably and generally refer to a type of system that displays holographic content (i.e. holograms). In some cases, ER system 110 is of a type that allows a user to see various portions of the real world and that also displays virtualized content in the form of holograms. That ability means ER system 110 is able to provide so-called “passthrough images” to the user. In other scenarios, the ER system 110 is a virtual reality system such that direct viewing of the real world is not available. Architecture 100 can be implemented on any MR, AR, or VR system.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 120 environment. In some implementations, service 105 is a local service operating on a local device, such as the ER system 110. In some implementations, service 105 is a hybrid service that includes a cloud component operating in the cloud 120 and a local component operating on a local device. These two components can communicate with one another.

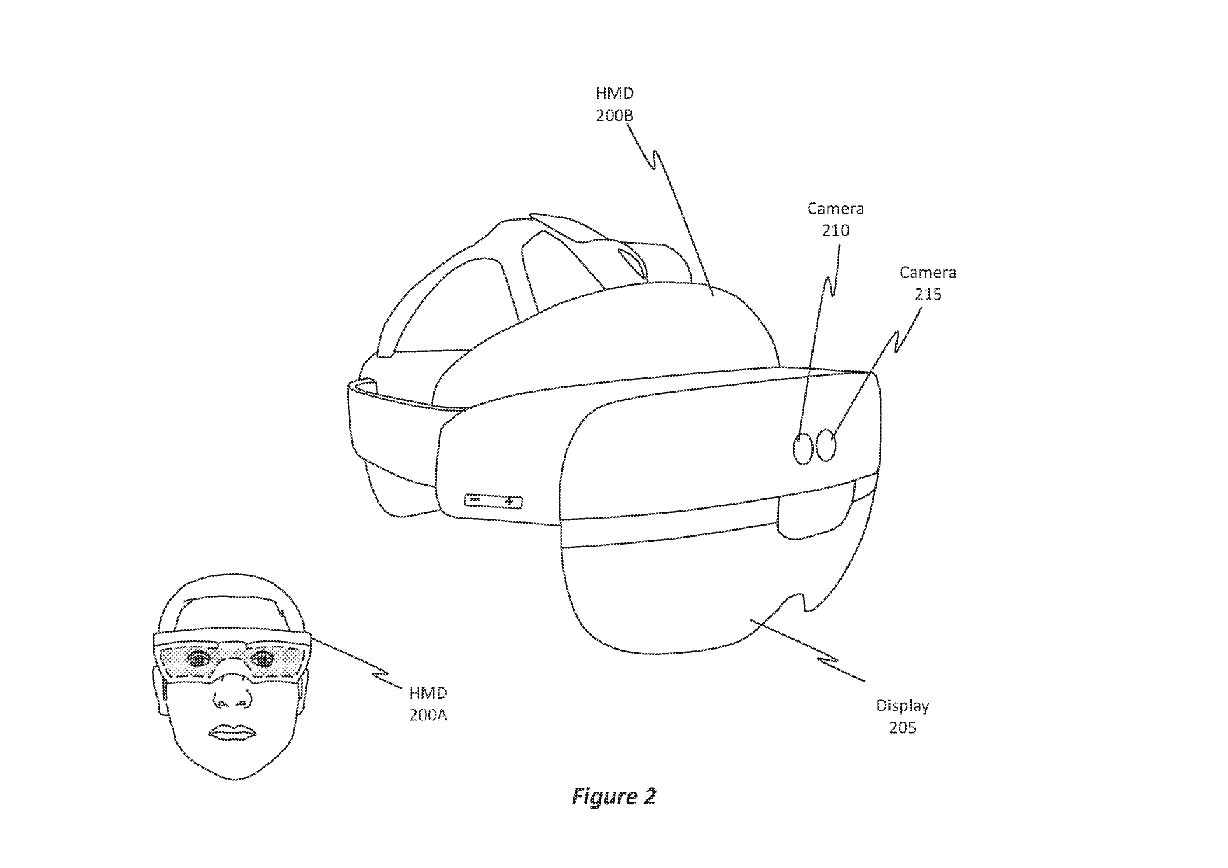

Turning briefly to FIG. 2, HMDs 200A and 200B are shown, where these HMDs are representative of the ER system 110 of FIG. 1. The phrases “HMD” and “ER system” can be used interchangeably.

HMD 200B includes a display 205, which may include a left display that is visible to the user’s left eye and a right display that is visible to the user’s right eye. Together, these two displays can provide binocular stereoscopic vision to the user.

By displaying holograms or any type of image content at specific pixel positions relative to one another, HMD 200B can display content in a manner such that the user perceives the content as having depth relative to the user. To illustrate, HMD 200B displays a first image in the left display and a second, different (though related) image in the right display. The user will view these two separate images, and the user’s mind can fuse them, thereby allowing the user to perceive depth with respect to the holograms.

HMD 200B can also be equipped with any number of cameras, such as camera 210 and camera 215. These cameras 210 and 215 can generate images that may be used to produce passthrough images.

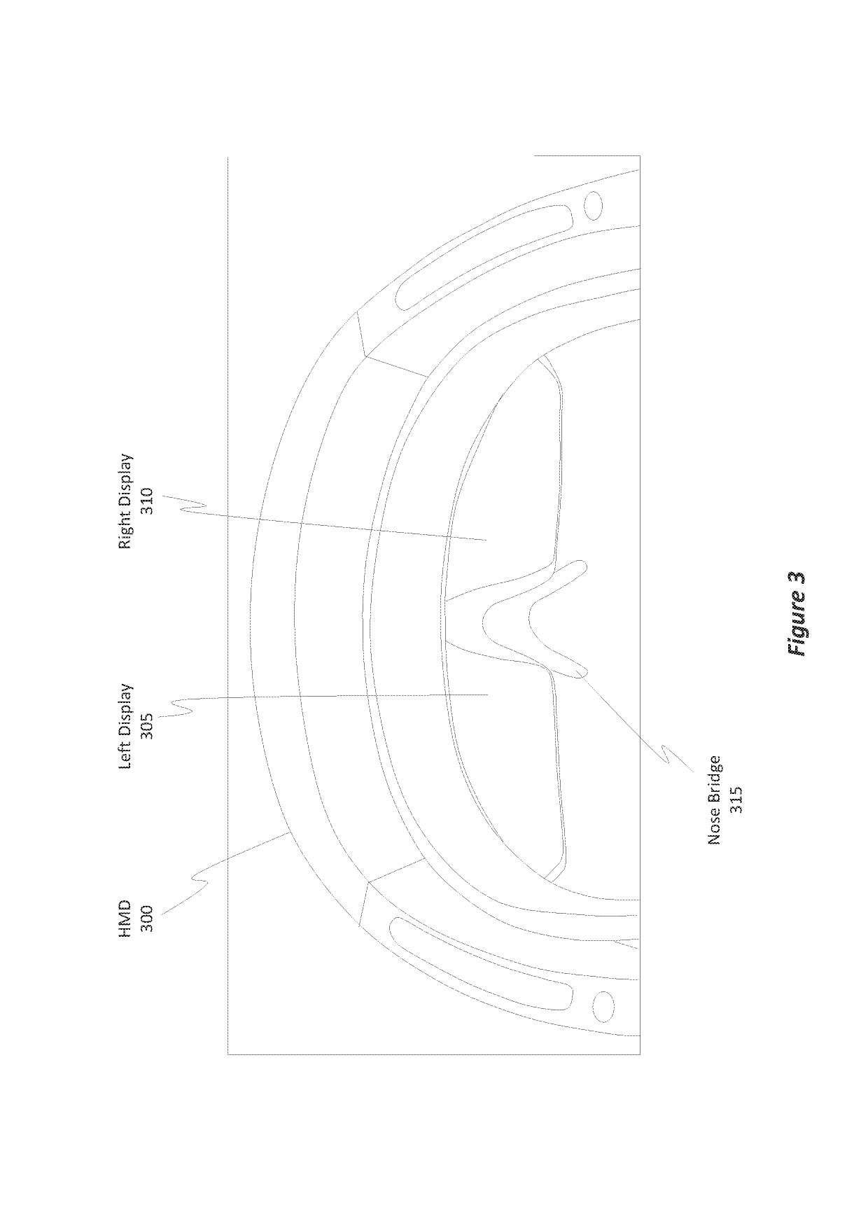

FIG. 3 shows another perspective view (e.g., top looking down view) of an HMD 300, which is representative of the ER systems and HMDs mentioned thus far. HMD 300 is shown as including a left display 305 and a right display 310 as well as a support feature in the form of a nose bridge 315.

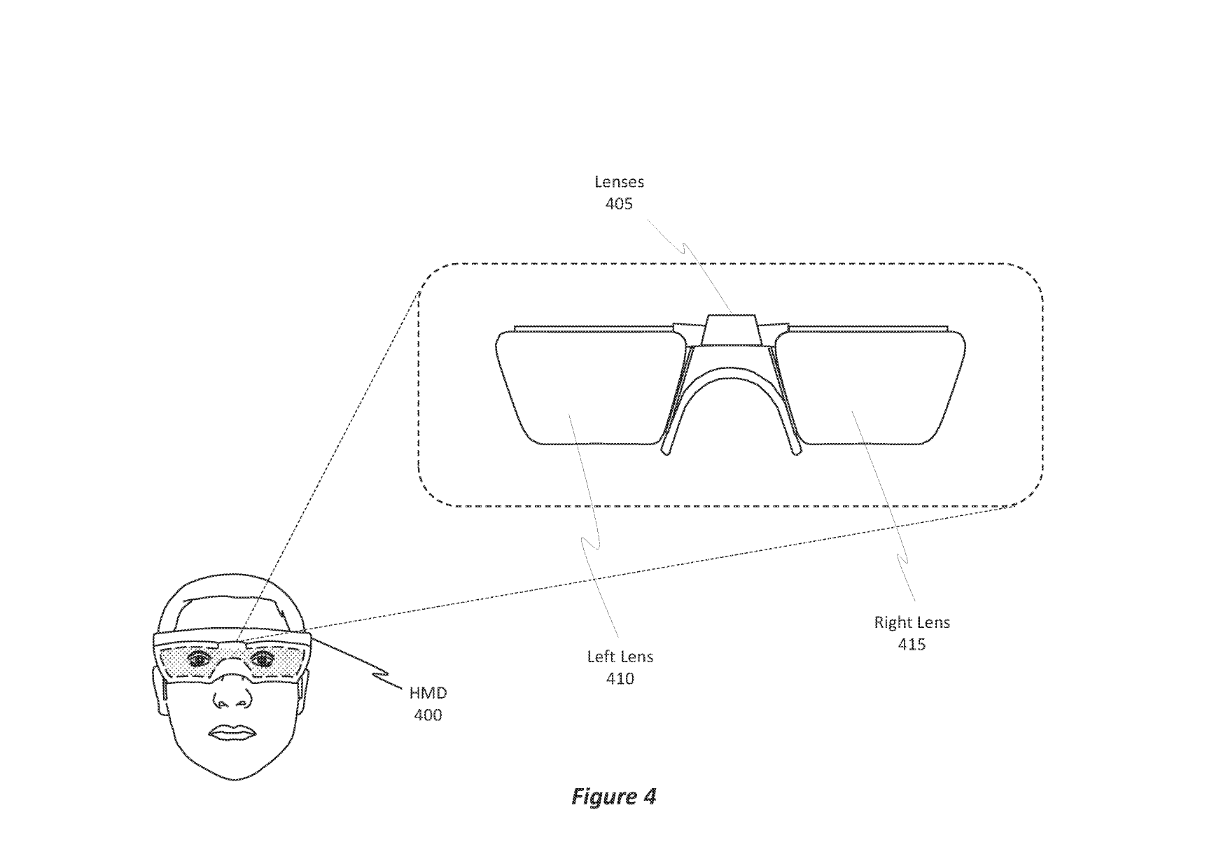

In accordance with the disclosed principles, HMD 300 is further equipped or is further configured to operate in conjunction with a set of corrective lenses. FIG. 4 is illustrative.

FIG. 4 shows an HMD 400 that is representative of HMD 300. A set of lenses 405, which include a left lens 410 and a right lens 415, can be used in conjunction with HMD 400. In some scenarios, the lenses 405 are insertable lenses that can be inserted, attached, affixed, or otherwise coupled to the HMD 400 in a secure manner. Optionally, the lenses 405 may be a permanent feature of the HMD 400 or a removable feature of the HMD 400. In some scenarios, the lenses 405 may be the user’s own pair of glasses, and the HMD 400 can fit over the user’s head while the user is wearing his/her glasses.

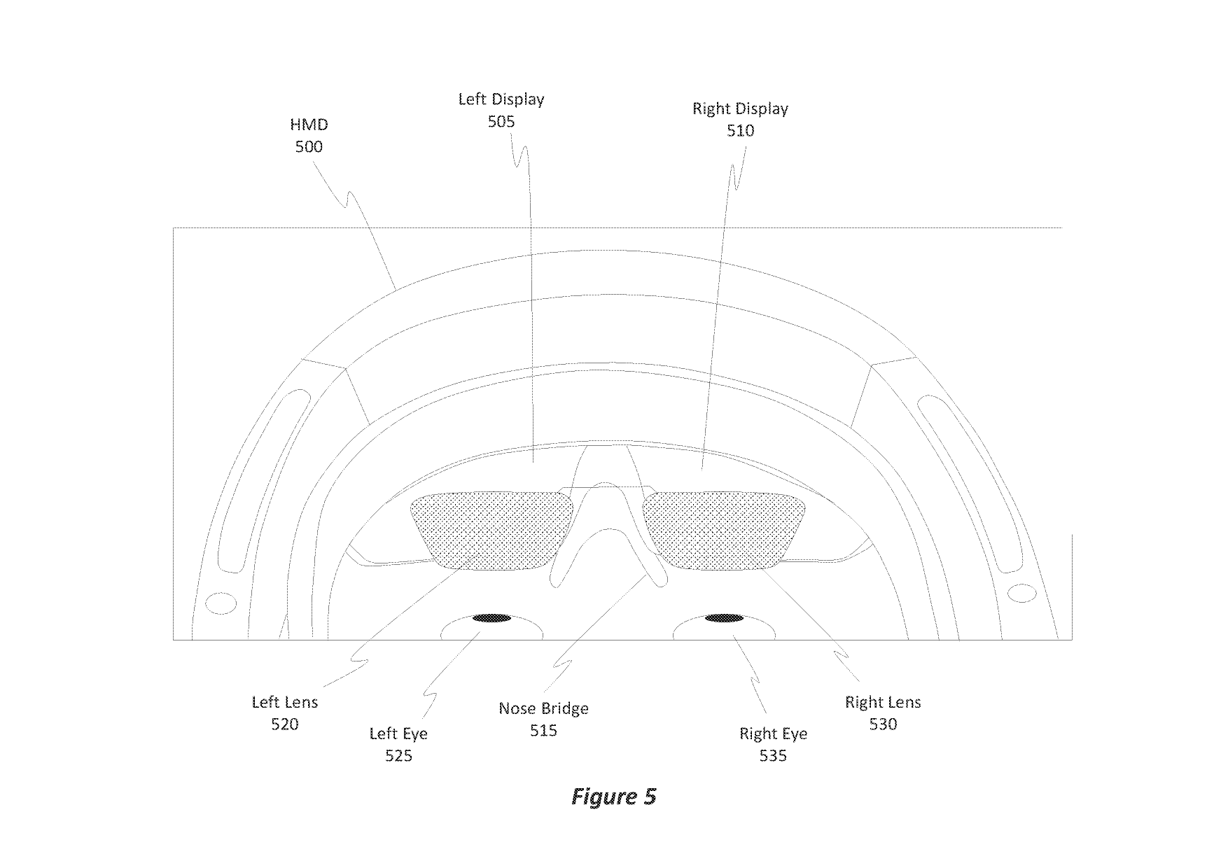

Regardless of whether the lenses 405 are permanent with respect to the HMD 400, semi-permanent (i.e. they are securely coupled to the HMD 400 but can be removed with respect to the HMD 400), or not a part of the HMD 400, the disclosed embodiments are configured to enable the HMD 400 to operate in conjunction with the lenses 405. Further details will be provided later, but FIG. 5 shows an example scenario in which the lenses are operating in conjunction with the HMD.

FIG. 5 shows an HMD 500 that is representative of the HMDs discussed thus far. HMD 500 includes a left display 505, a right display 510, and a nose bridge 515. Additionally, FIG. 5 shows a left lens 520, through which the user’s left eye 525 can look to observe the left display 505, and a right lens 530, through which the user’s right eye 535 can look to observe the right display 510. The left and right lenses 520 and 530 are examples of intervening lenses that are positioned between the user’s eyes and the HMD’s display. For reference going forward, the area between the user’s eyes and the intervening lenses is referred to as the “eye-side” of the lenses while the area between the intervening lenses and the display is referred to as the “display-side” of the lenses.

In some scenarios, the left lens 520 is separate from and is not attached to the right lens 530. Optionally, HMD 500 can include recessed portions or insertion areas into which the user can individually insert the left lens 520 and the right lens 530. In some scenarios, the left lens 520 is attached to the right lens 530, similar to how glasses attach or couple two lenses together. Optionally, the HMD 500 can include a clip or connection mechanism for receiving and securely coupling the lenses to the HMD 500.

Notice, in particular, the placement of the lenses relative to the HMD’s display and the user’s eyes. Specifically, the left lens 520 is disposed at a position that is between the user’s left eye 525 and the left display 505. As a consequence, content displayed on the left display 505 will be visible to the user’s left eye 525 through the left lens 520. Stated differently, the user’s left eye 525 will observe the content displayed in the left display 505 via whatever refraction (e.g., magnification, minification, etc.) occurs as a result of the left lens 520 being disposed between the left display 505 and the user’s left eye 525.

Similarly, the right lens 530 is disposed at a position that is between the user’s right eye 535 and the right display 510. As a consequence, content displayed on the right display 510 will be visible to the user’s right eye 535 through the right lens 530. Stated differently, the user’s right eye 535 will observe the content displayed in the right display 510 via whatever refraction (e.g., magnification, minification, etc.) occurs as a result of the right lens 530 being disposed between the right display 510 and the user’s right eye 535.

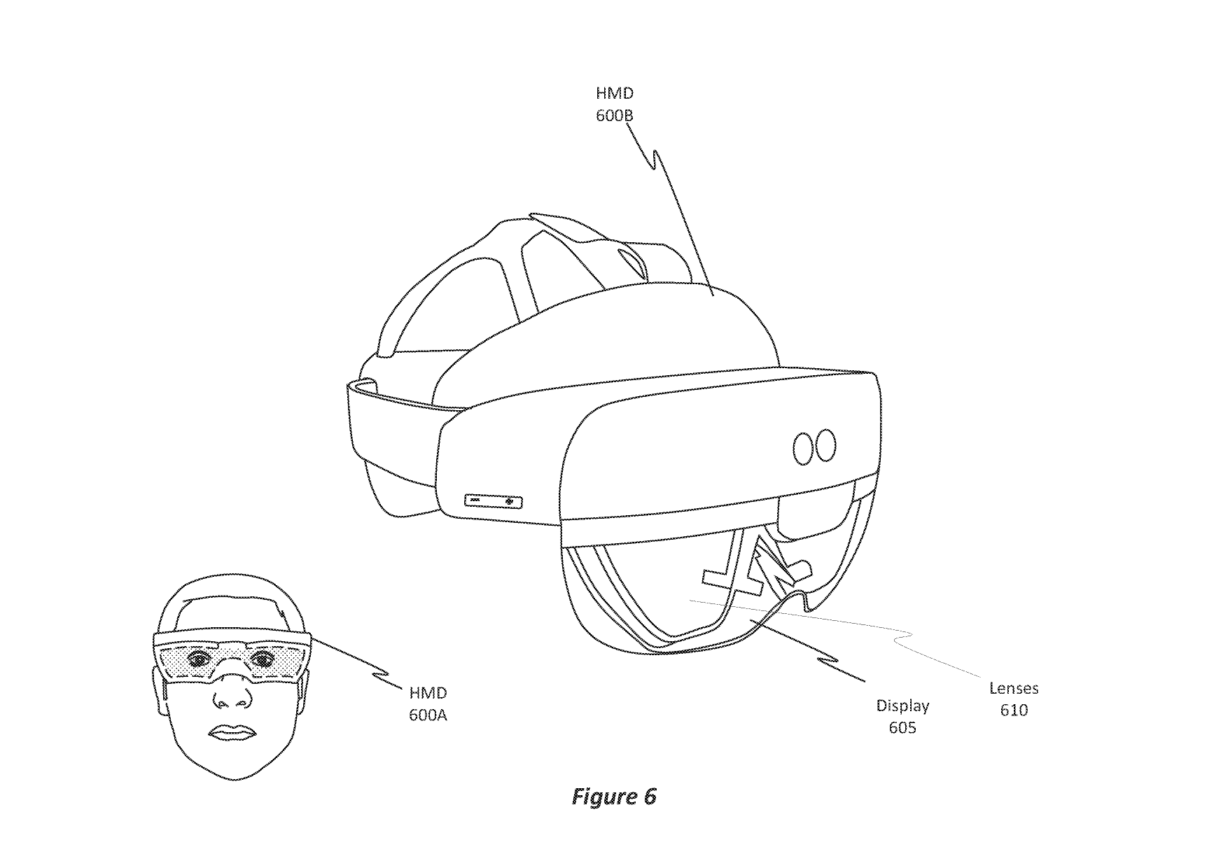

FIG. 6 shows an alternative perspective view of the HMD 600A and 600B. Notice, HMD 600B includes a display 605. In this scenario, the lenses 610 are coupled to the HMD 600B. Thus, when the user wears the HMD 600B, the user will observe the content displayed on the display 605 by looking through the lenses 610.

Returning to FIG. 1, service 105 is tasked with accessing diopter information 125. For instance, the user can enter his/her prescription or diopter information in any manner. In one scenario, the information can be entered directly by the user, such as by entering the values. In another scenario, the user can enter or upload a doctor’s prescription.

Service 105 will also access a set of input image(s) 130. For instance, a left image may be configured for display on the left display of the ER system 110, and a right image may be configured for display on the right display of the ER system 110. The image(s) 130 may be structured to include any type of content, such as holograms or passthrough content.

Recall, if the image(s) 130 (e.g., a pair of stereoscopic images comprising a left image and a right image) were to be displayed in their default, same-sized state, the refractive properties of the intervening lenses would cause disparate sized images to be visible on the eye-side of the intervening lenses. Such a scenario would cause discomfort on the part of the user.

To account for the refractive properties of the intervening lenses, service 105 determines how much scaling correction to apply to the image(s) 130. That is, service 105 can determine what level of correction (e.g., reduce or increase image magnification) is to be applied to the image(s) 130 so that, when the image(s) 130 are viewed on the eye-side of the intervening lenses, the two images appear to have the same size. Thus, service 105 will modify the sizes of the image(s) 130 prior to those image(s) 130 being displayed so that the image(s) 130, as presented on the display, will have different sizes but also so that the image(s) 130, as viewed on the eye-side of the intervening lenses, will have the same or substantially the same size.

One modification technique involves scaling the digital stereoscopic images separately to accommodate each diopter characteristic of each lens, thereby correcting for size disparities. For instance, the image(s) 130 may initially have the same size (i.e. the same magnification). As mentioned above, if these same-sized images were displayed on the ER system’s display, the user would perceive those images in a skewed manner due to the magnification effects imposed by the intervening lenses that are positioned between the user’s eyes and the display. To account for these magnification effects, service 105 scales or corrects the image(s) 130 prior to them being displayed. An example will be helpful.

Suppose the user’s right eye has perfect vision and no corrective lens is needed. In contrast, suppose the user’s left eye suffers from myopia, and the user’s left eye prescription reading is -4.00. In this scenario, no corrective lens is used for the user’s right eye, but a corrective lens having a prescription reading of -4.00 is used for the user’s left eye.

Prior to display, the left image and the right image (collectively the image(s) 130) are of the same size. If these two images were displayed on the ER system’s display, the user would correctly view the right image. The left image, however, would be viewed by the user’s left eye through the lens. The lens would have a magnifying effect, and the user would view the left image (on the eye-side of the intervening lens) as being significantly different in size relative to the right image. This difference in image size would cause significant discomfort to the user.

To compensate for such a scenario, service 105 scales the left image by a scaling factor that is based on the user’s diopter prescription information (e.g., in the above example -4.00). In the above example, the image is reduced in size (though the pixel count may remain the same, resulting in a higher pixel density image). The scaled image is displayed on the left display, and the unscaled image is displayed on the right display. The user views the scaled image through the lens, and the result is the image appears to be the same size as the right (unscaled) image. Thus, service 105 applies a scaling factor to the images, prior to them being displayed, and the scaling factor is designed to account for one or more intervening lenses. Notably, if the image(s) 130 were viewed on the display without the use of the intervening lenses, then the image(s) 130 will appear on the display as having different sizes.

Accordingly, service 105 can analyze the image size difference and can adjust the images. The displayed versions of the images will potentially be different (though they may be the same if the user’s prescription is the same in both eyes) in size relative to one another because of potential differences in the user’s left and right prescriptions. Looking at the displays through the intervening lenses, however, will cause the two images to appear as if they have the same size. That is, at the eye-side of the lenses, the two images will appear as if they have the same size. At the display-side of the lenses, the two images may potentially have different sizes depending on the scaling factors used, which are based on the user’s diopter information. Thus, at the position of the user’s eye, the left image and the right image will appear as having the same size.

Another technique involves the use of real-time dynamic resizing algorithms that automatically adjust the size of the images based on the detected disparity between the left and right eye views. Such a technique is particularly beneficially for situations involving progressive lenses. This technique can be integrated into 3D rendering software or VR systems to ensure consistent image sizes during viewing. Thus, different scaling parameters can be used to mimic how progressive lenses operate. Another technique involves the viewing distance and how it can impact the perceived size of images in stereoscopic systems. By adjusting the distance between the display and the viewer, or between the two image planes, it is possible to reduce the apparent difference in image sizes.

Accordingly, service 105 is tasked with accessing the diopter information 125 and the image(s) 130. Service 105 then determines an image size delta 135, which refers to the difference in size between the initially rendered image and the scaled image used to account for the refractive properties of the intervening lens(es). As an example, suppose the initially rendered image has a size of 1x, but this size will result in an improperly magnified image due to the placement of the intervening lens. Instead, a scaled image of size 0.75x should be displayed so that, when the 0.75x image is viewed through the lens, the image is of a correct size on the eye-side of the intervening lens. By “correct,” it is meant that the image has the same size as the other stereoscopic image when viewed on the eye-side of the intervening lens. In this scenario, the image size delta 135 corresponds to the difference between 1.0x and 0.75x.

The image size delta 135 can optionally be used by service 105 to then compute, generate, or otherwise determine scaling factor(s) 140 that are applicable to the images to scale (e.g., magnify, minify, etc.) the images when they are displayed on the displays. These scaling factor(s) 140 can be computed on demand or they can be stored in a lookup table 140A that includes scaling factors mapped to diopter information. If the user has the same prescription for both eyes, the scaling factor(s) 140 may be the same. If the user has different prescriptions, the scaling factor(s) 140 will be different.

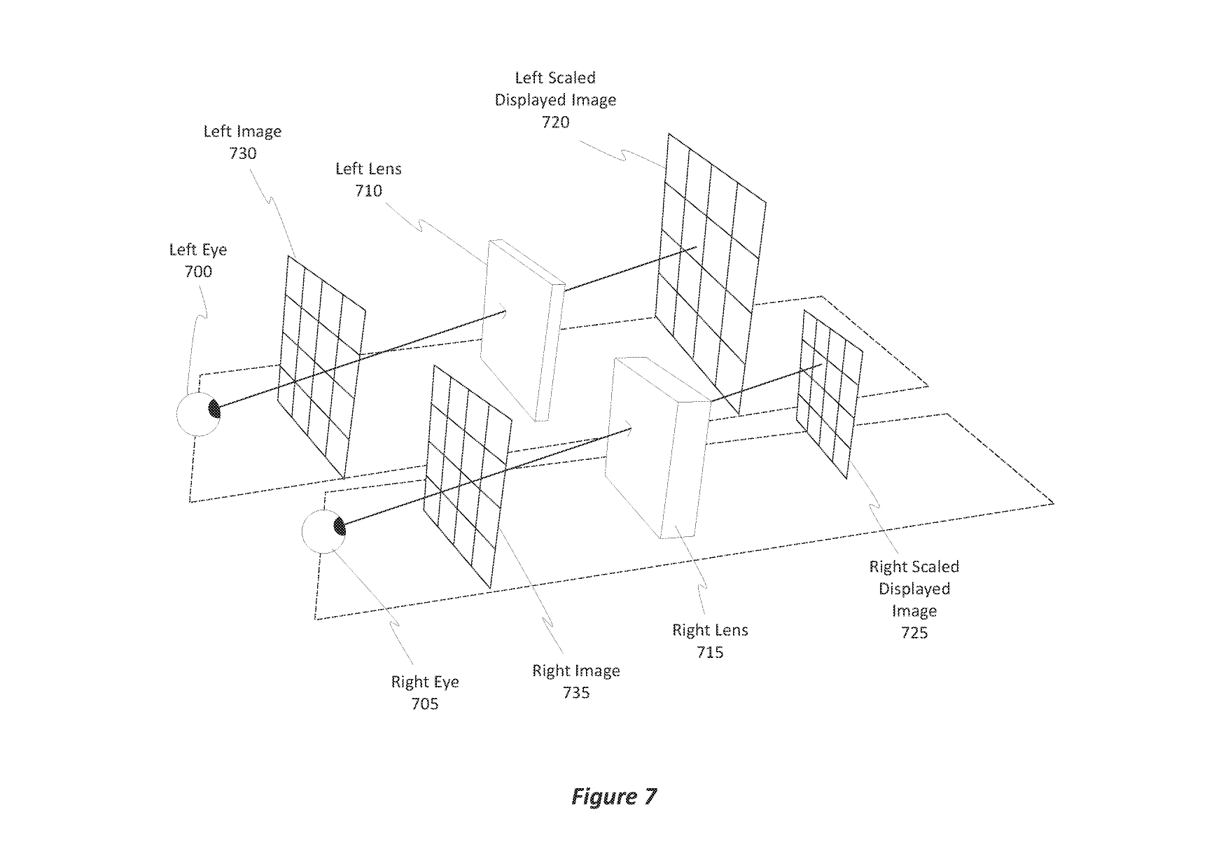

The sizes of the scaled images (i.e. image size(s) 145) are determined by applying the scaling factor(s) 140 to the image(s) 130. The result of applying the scaling factor(s) 140 to the image(s) 130 is a set of scaled image(s) 150. The scaled image(s) 150 can then be displayed on the ER system’s display. FIG. 7 provides a useful illustration.

FIG. 7 shows the user’s left eye 700 and the user’s right eye 705. FIG. 7 also shows a left lens 710 and a right lens 715, which correspond to the left lens 520 of FIG. 5 and the right lens 530, respectively. Notice, in this scenario, the size of the left lens 710 is different than the size of the right lens 715, suggesting that the user has different prescriptions in his/her eyes. Service 105 of FIG. 1 is able to receive the prescription or diopter information for the left lens 710 and the right lens 715.

In accordance with the disclosed principles, service 105 will access a set of initially unscaled images, one selected for display on the HMD’s left display and one selected for display on the HMD’s right display. After obtaining a set of one or more scaling factors (e.g., one for the left image and one for the right image based on the diopter information), service 105 will apply the left image scaling factor to the left image and the right image scaling factor to the right image. Service 105 will then cause those scaled images to be displayed.

To illustrate, FIG. 7 shows a left scaled displayed image 720 and a right scaled displayed image 725. The left scaled displayed image 720 is displayed on the left display of the HMD, and the right scaled displayed image 725 is displayed on the right display of the HMD. Notice, in FIG. 7, because different scaling factors were used on the left and right images (due to the diopter differences in the left and right lenses 710 and 715), the size of the left scaled displayed image 720 is different than the size of the right scaled displayed image 725. In some scenarios, the pixel resolutions between the two images may remain the same while in other scenarios the pixel resolutions may be different between the two images.

Notice, however, that on the eye-side of the left and right lenses 710 and 715, there are two images, namely, the left image 730 and the right image 735. The left image 730 and the right image 735 are shown as having the same size in FIG. 7. Service 105 purposefully displayed the left scaled displayed image 720 and the right scaled displayed image 725 using different sizes because, when those images are viewed through the lenses 710 and 715, the resulting images (e.g., left image 730 and right image 735) will have the same size on the eye-side of the lenses. Thus, service 105 modifies a display size of an image based on diopter information of an intervening lens that is disposed between the user’s eye and the corresponding display.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

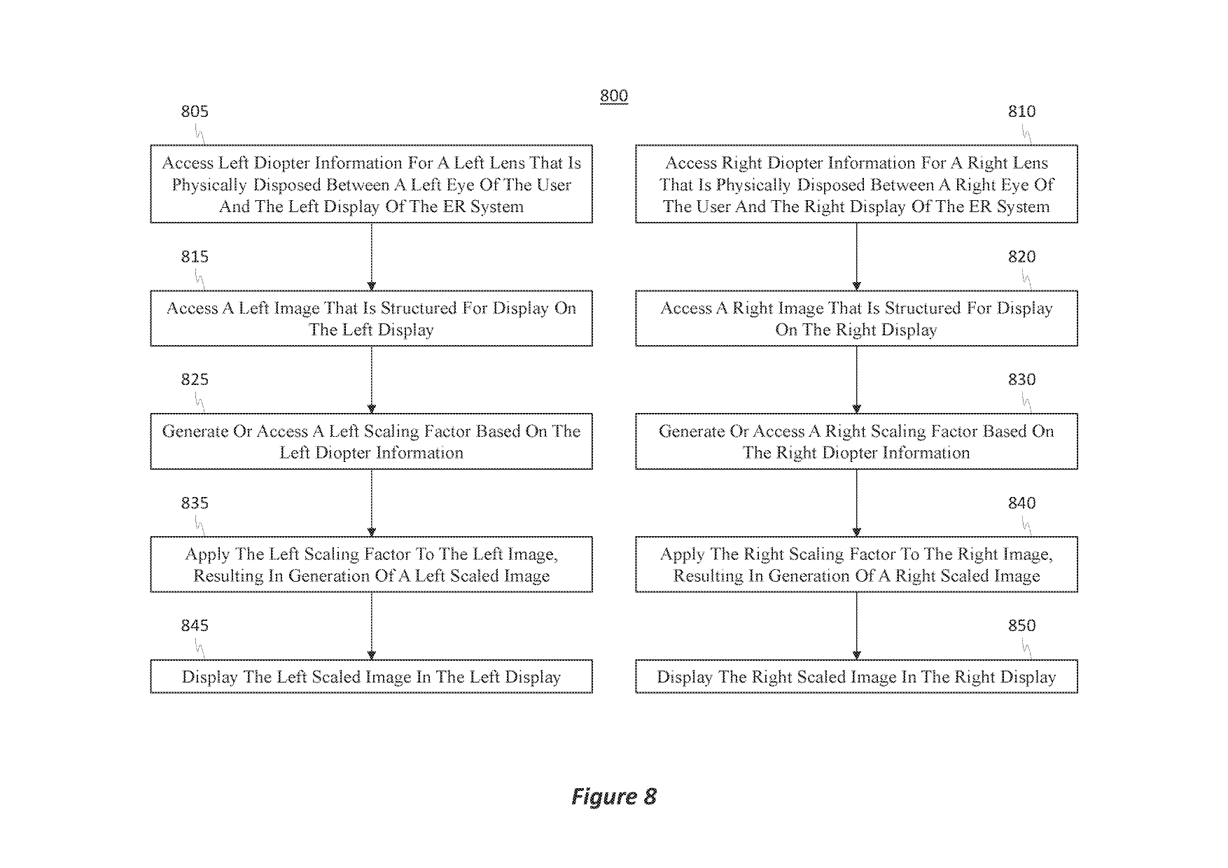

Attention will now be directed to FIG. 8, which illustrates a flowchart of an example method 800 for scaling an image in an extended-reality (ER) system to calibrate the image for a vision prescription of a user wearing the ER system. Method can be implemented within the computing architecture 100 of FIG. 1. Method 800 can be performed by the ER system 110, which may include a left display and a right display. Also, method 800 can be performed by service 105, which can operate on the ER system 110. Method 800 shows to columns of actions. The actions in one column can be performed in parallel with the actions in the other column.

Method 800 includes an act (act 805) of accessing left diopter information for a left lens that is physically disposed between a left eye of the user and a left display of the ER system. Optionally, the left lens is coupled to the ER system. Alternatively, the left lens is separate from the ER system.

Act 810 includes accessing right diopter information for a right lens that is physically disposed between a right eye of the user and a right display of the ER system. Optionally, the right lens is coupled to the ER system. Alternatively, the right lens is separate from the ER system.

The left and right diopter information may be entered via user input by the user. Optionally, the left and right diopter information can be obtained from prescription information for the user. In some scenarios, the left diopter information is different than the right diopter information. In other scenarios, the left diopter information is the same as the right diopter information.

Act 815 includes accessing a left image that is structured for display on the left display. The left image can be included among the image(s) 130 of FIG. 1 and is one image included in a pair of stereoscopic images.

Act 820 includes accessing a right image that is structured for display on the right display. The right image can be included among the image(s) 130 of FIG. 1 and is the other image included in the pair of stereoscopic images.

Act 825 includes generating or accessing a left scaling factor based on the left diopter information. Act 830 includes generating or accessing a right scaling factor based on the right diopter information. In some embodiments, the left and right scaling factors are accessed from a lookup table. In other embodiments, the left and right scaling factors are computed in real-time. The scaling factor(s) operate to magnify or minimize the size of the left and right images. In some scenarios, both images are magnified. In other scenarios, both images are minimized. In some scenarios, one image is magnified while the other is minimized. In some scenarios, one image is either magnified or minimized while the other image remains unchanged.

In some scenarios, the left scaling factor is different than the right scaling factor. In other scenarios, the left scaling factor is the same as the right scaling factor. In some scenarios, only one of the left or right scaling factors is a value of one (i.e. no scaling occurs) while the other one of the left or right scaling factors is a value other than one.

Prior to the left image being displayed in the left display, act 835 includes applying the left scaling factor to the left image. The application of the left scaling factor to the left image results in the generation of a left scaled image.

Prior to the right image being displayed in the right display, act 840 includes applying the right scaling factor to the right image. The application of the right scaling factor to the right image results in the generation of a right scaled image.

Act 845 includes displaying the left scaled image in the left display. Optionally, the left scaled image is one of a magnified version of the left image or a minimized version of the left image or even an unscaled version of the left image.

Act 850 includes displaying the right scaled image in the right display. Optionally, the right scaled image is one of a magnified version of the right image or a minimized version of the right image or even an unscaled version of the right image.

In some scenarios, a first size of the left scaled image, as displayed on the left display, is different than a second size of the right scaled image, as displayed on the right display. In other scenarios, the first size of the left scaled image, as displayed on the left display, is the same as the second size of the right scaled image, as displayed on the right display.

In some embodiments, the left scaled image is one of a left magnified version of the left image or a left minimized version of the left image. Similarly, the right scaled image is one of a right magnified version of the right image or a right minimized version of the right image.

Notably, the left scaling factor is designed to cause the left scaled image, as viewed on the left display through the left lens (i.e. the eye-side of the intervening lens), to be of a first size. Similarly, the right scaling factor is designed to cause the right scaled image, as viewed on the right display through the right lens (i.e. the eye-side of the intervening lens), to be of the same first size. Stated differently, the scaling factor is designed to cause one of the scaled images, as viewed on the display through the lens, to be of a predetermined size. The predetermined size is a size that matches a second size of a second image, which is viewed on a second display of the ER system through a second lens. Stated differently, the predetermined size is one that matches the size of the other image, as viewed by the user’s other eye. By performing the disclosed operations, the embodiments advantageously improve user comfort with ER systems.

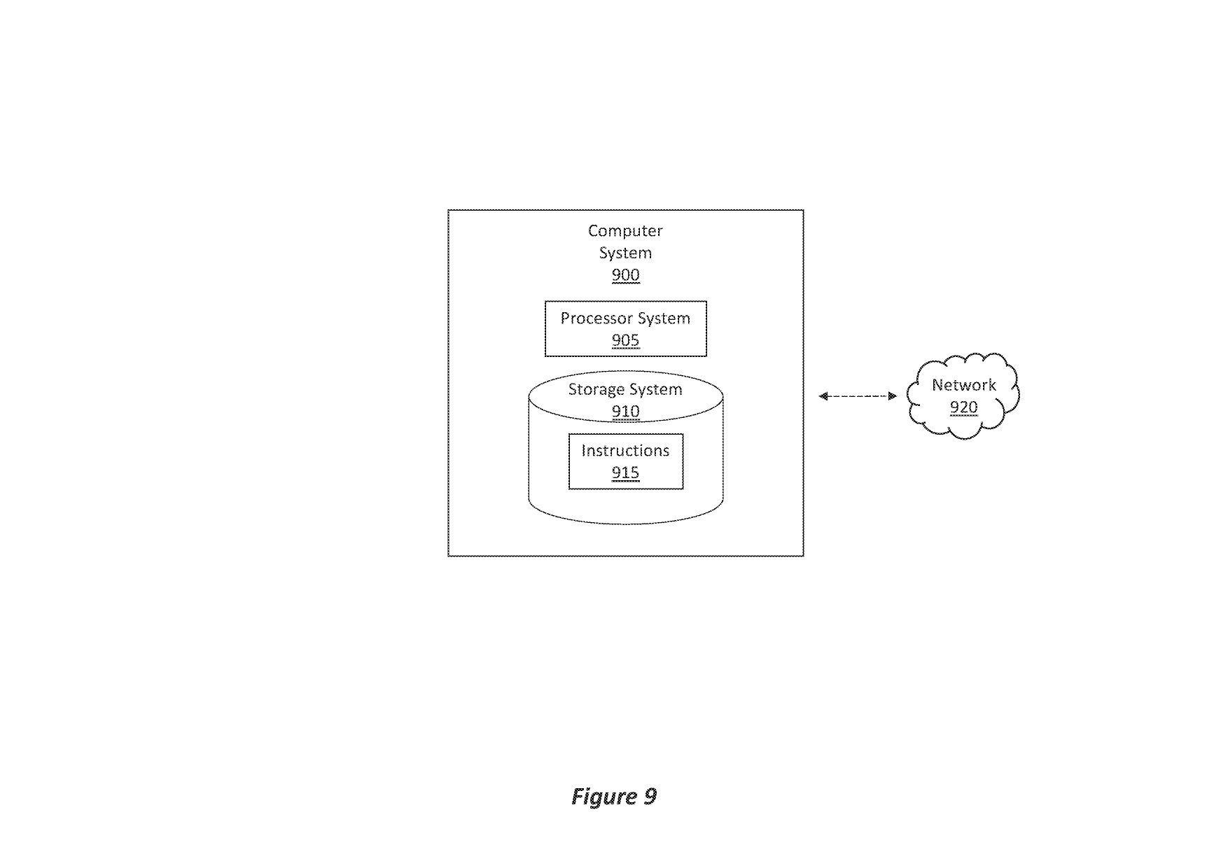

Attention will now be directed to FIG. 9 which illustrates an example computer system 900 that may include and/or be used to perform any of the operations described herein. For instance, computer system can implement service 105 of FIG. 1. Computer system can also take the form of ER system 110.

Computer system 900 may take various different forms. For example, computer system 900 may be embodied as a tablet, a desktop, a laptop, a mobile device, or a standalone device, such as those described throughout this disclosure. Computer system 900 may also be a distributed system that includes one or more connected computing components/devices that are in communication with computer system 900.

In its most basic configuration, computer system 900 includes various different components. FIG. 9 shows that computer system 900 includes a processor system 905, which may include one or more processor(s) (aka a “hardware processing unit”) and a storage system 910.

Regarding the processor(s) of processor system 905, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 900. The different components, modules, engines, and services described herein may be implemented as objects or processors that execute on computer system 900 (e.g. as separate threads).

Storage system 910 may be physical system memory, which may be volatile, non-volatile, or some combination of the two. The term “memory” may also be used herein to refer to non-volatile mass storage such as physical storage media. If computer system 900 is distributed, the processing, memory, and/or storage capability may be distributed as well.

Storage system 910 is shown as including executable instructions 915. The executable instructions 915 represent instructions that are executable by the processor(s) of processor system 905 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 900 may also be connected (via a wired or wireless connection) to external sensors (e.g., one or more remote cameras) or devices via a network 920. For example, computer system 900 can communicate with any number devices or cloud services to obtain or process data. In some cases, network 920 may itself be a cloud network. Furthermore, computer system 900 may also be connected through one or more wired or wireless networks to remote/separate computer systems(s) that are configured to perform any of the processing described with regard to computer system 900.

A “network,” like network 920, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 900 will include one or more communication channels that are used to communicate with the network 920. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for scaling an image in an extended-reality (ER) system to calibrate the image for a vision prescription of a user wearing the ER system, said method being performed by the ER system and comprising:
accessing diopter information for a lens that is physically disposed between an eye of the user and a display of the ER system;
accessing the image, which is structured for display on the display;
generating or accessing a scaling factor based on the diopter information;
prior to the image being displayed in the display, applying the scaling factor to the image, resulting in generation of a scaled image that is a magnified or minimized version of the image; and
displaying the scaled image in the display,
wherein:
the scaling factor is designed to cause the scaled image, as viewed on the display through the lens, to be of a predetermined size.

2. The method of claim 1, wherein the predetermined size is a size that matches a second size of a second image, which is viewed on a second display of the ER system through a second lens.

3. The method of claim 1, wherein the lens is coupled to the ER system.

4. The method of claim 1, wherein the lens is separate from the ER system.

5. The method of claim 1, wherein the scaled image is the magnified version of the image.

6. The method of claim 1, wherein the scaled image is the minimized version of the image.

7. A method for scaling an image in an extended-reality (ER) system to calibrate the image for a vision prescription of a user wearing the ER system, said method being performed by the ER system and comprising:
accessing left diopter information for a left lens that is physically disposed between a left eye of the user and a left display of the ER system;
accessing right diopter information for a right lens that is physically disposed between a right eye of the user and a right display of the ER system;
accessing a left image that is structured for display on the left display;
accessing a right image that is structured for display on the right display;
generating or accessing a left scaling factor based on the left diopter information;
generating or accessing a right scaling factor based on the right diopter information;
prior to the left image being displayed in the left display, applying the left scaling factor to the left image, resulting in generation of a left scaled image;
prior to the right image being displayed in the right display, applying the right scaling factor to the right image, resulting in generation of a right scaled image;
displaying the left scaled image in the left display; and
displaying the right scaled image in the right display,
wherein:
the left scaling factor is designed to cause the left scaled image, as viewed on the left display through the left lens, to be of a first size, and
the right scaling factor is designed to cause the right scaled image, as viewed on the right display through the right lens, to be of the same first size.

8. The method of claim 7, wherein the left diopter information is entered via user input by the user, and wherein the right diopter information is also entered via the user input by the user.

9. The method of claim 7, wherein the left scaled image is a magnified version of the left image.

10. The method of claim 7, wherein the right scaled image is a minimized version of the right image.

11. The method of claim 7, wherein the left scaled image is a magnified version of the left image, and wherein the right scaled image is a magnified version of the right image.

12. The method of claim 7, wherein the left scaled image is one of a left magnified version of the left image or a left minimized version of the left image, and wherein the right scaled image is one of a right magnified version of the right image or a right minimized version of the right image.

13. The method of claim 7, wherein the left scaling factor is different than the right scaling factor.

14. The method of claim 7, wherein the left diopter information is different than the right diopter information.

15. The method of claim 7, wherein a first size of the left scaled image, as displayed on the left display, is different than a second size of the right scaled image, as displayed on the right display.

16. An extended reality (ER) system comprising:
a left display;
a right display;
a processor system; and
a storage system that stores instructions that are executable by the processor system to cause the ER system to:
access left diopter information for a left lens that is physically disposed between a left eye of the user and the left display of the ER system;
access right diopter information for a right lens that is physically disposed between a right eye of the user and the right display of the ER system;
access a left image that is structured for display on the left display;
access a right image that is structured for display on the right display;
access a left scaling factor based on the left diopter information;
access a right scaling factor based on the right diopter information;
prior to the left image being displayed in the left display, apply the left scaling factor to the left image, resulting in generation of a left scaled image;
prior to the right image being displayed in the right display, apply the right scaling factor to the right image, resulting in generation of a right scaled image;
display the left scaled image in the left display; and
display the right scaled image in the right display,
wherein:
the left scaling factor is designed to cause the left scaled image, as viewed on the left display through the left lens, to be of a first size, and
the right scaling factor is designed to cause the right scaled image, as viewed on the right display through the right lens, to be of the same first size.

17. The ER system of claim 16, wherein the left scaling factor and the right scaling factor are accessed from a lookup table.

18. The ER system of claim 16, wherein the left scaling factor is different than the right scaling factor.

19. The ER system of claim 16, wherein the left diopter information is different than the right diopter information.

20. The ER system of claim 16, wherein a first size of the left scaled image, as displayed on the left display, is different than a second size of the right scaled image, as displayed on the right display.
